(19) United States
(12) Patent Application Publication
(10) Pub. No.: US 2016/0009120 A1
(43) Pub. Date: Jan. 14, 2016

(54) Paper Binding Device

(71) Applicant: Pei-Chin Kao, Taoyuan City (TW)

(72) Inventor: Pei-Chin Kao, Taoyuan City (TW)

(21) Appl. No.: 14/571,390

(22) Filed: Dec. 16, 2014

(30) Foreign Application Priority Data
Jul. 11, 2014 (TW) 103123922

(51) Int. Cl. B42F 1/10

(52) U.S. Cl. CPC B42F 1/10

(57) ABSTRACT

A paper binding device includes a bottom plate and a fastening strap having a first engagement side and a second engagement side configured to repeatedly and releasably engage with the first engagement side. A portion of the first or second engagement side is fixed to the bottom plate. In another example, the paper binding device includes a bottom plate and first and second fastening straps. Each of the first fastening strap and the second fastening strap includes a first engagement side and a second engagement side. The second engagement side of the first fastening strap is configured to repeatedly and releasably engage with the first engagement side of the second fastening strap. The first engagement side at an end of the first fastening strap and the second engagement side at an end of the second fastening strap are respectively fixed to two ends of the bottom plate.

### BACKGROUND OF THE INVENTION

The present invention relates to a paper binding device and, more particularly, to an improved paper binding device proving convenience and reliable use.

Arrangement and binding of paper are common in offices. Various paper fasteners and paper binders have been provided in the market to meet this need. FIGS. 1A and 1B show a conventional paper fastener including a fastening member 10 and an elongated, flexible prong fastener 20. The fastening member 10 includes two sliding fasteners 11 and two holes 12 in each of two ends of the fastening member 10. The spacing between the holes 12 is equal to a hole spacing of a paper punch. In use, the fastening member 10 is placed on top of a paper 1 that has been punched by a paper punch, with the holes 1′ of the paper 1 aligned with the holes 12 of the fastening member 10. Next, the prongs of the prong fastener 20 extend through the holes 1′ of the paper 1 and the holes 12 of the fastening member 10. Then, the prongs of the prong fastener 20 are bent to abut the fastening member 10, and the two sliding fasteners 11 are moved to appropriate positions to retain the prongs of the prong fastener 20 in place to accomplish binding of the paper 1.

However, the conventional paper fastener still has disadvantages although it can bind paper. For example, the fastening member 10 and the prong fastener 20 are separate members that must work together to perform the desired function. Losing either member will cause inconvenience in use. Furthermore, movement of the two sliding fasteners 11 is required for binding or removing the paper 1, which is troublesome and inconvenient in use. Furthermore, the conventional paper fastener does not have any mechanism for positioning the two sliding fasteners 11 such that the paper 1 cannot be properly and securely bound. Furthermore, the two sliding fasteners 11 of the fastening member 10 of the conventional paper fastener result in complicated manufacturing and complicated assembly as well as high costs.

Thus, a need exists for a novel paper binding device to mitigate and/or obviate the above disadvantages.

### BRIEF SUMMARY OF THE INVENTION

An objective of the present invention is to provide a paper binding device having a simple structure, providing convenient use, reliably and securely binding paper, and permitting easy manufacture.

In an aspect, a paper binding device includes a bottom plate and a fastening strap. The fastening strap is elongated and includes a first engagement side and a second engagement side configured to repeatedly and releasably engage with the first engagement side. A portion of the first engagement side or a portion of the second engagement side is fixed to the bottom plate.

The fastening strap can be a hook and loop strap. The first engagement side has a plurality of hooks, and the second engagement side has a plurality of loops.

The fastening strap can be made of polyethylene terephthalate (PET) electrostatic film material or a re-adherable strap.

The fastening strap can be fixed to the bottom plate by gluing, heat welding, or supersonic welding.

The paper binding device can further include a peel paper mounted to one of the first and second engagement sides of the fastening strap opposite to the bottom plate.

The paper binding device can further an adhesive layer provided on a side of the bottom plate opposite to the fastening strap.

In an example, the paper binding device further includes a first board and a second board. The bottom plate is mounted to one of four sides of the first board. Two holes are defined in one of four sides of the second board corresponding to the one of the four sides of the first board. The fastening strap includes two ends adapted to extend through the two holes of the second board before the first engagement side engages with the second engagement side for detachably binding the second board to the first board.

In another example, the paper binding device further includes another bottom board fixed to another of the four sides of the first board and having first and second ends. The paper binding device further includes first and second fastening straps. Each of the first fastening strap and the second fastening strap includes a first engagement side and a second engagement side. The second engagement side of the first fastening strap is configured to repeatedly and releasably engage with the first engagement side of the second fastening strap. The first engagement side at an end of the first fastening strap is fixed to the first end of the another bottom plate. The second engagement side at an end of the second fastening strap is fixed to the second end of the another bottom plate. The second board further includes another two holes defined in another of the four sides of the second board corresponding to the another of the four sides of the first board. Each of the first and second fastening straps further includes another end adapted to extend through one of the another two holes of the second board. The second engagement side of the first fastening strap is adapted to releasably engage with the first engagement side of the second fastening strap for detachably binding the second board to the first board.

In a further example, the bottom board forms a first board. The portion of the first engagement side or the portion of the second engagement side is fixed to one of four sides of the first board. The paper binding device further includes a second board. Two holes are defined in one of four sides of the second board corresponding to the one of the four sides of the first board. The fastening strap includes two ends adapted to extend through the two holes of the second board before the first engagement side of the fastening strap engages with the second engagement side of the fastening strap for detachably binding the second board to the first board. In still another example, the paper binding device further includes first and second fastening straps. Each of the first fastening strap and the second fastening strap includes a first engagement side and a second engagement side. The second engagement side of the first fastening strap is configured to repeatedly and releasably engage with the first engagement side of the second fastening strap. The first engagement side at an end of the first fastening strap is fixed to another of the four sides of the first board. The second engagement side at an end of the second fastening strap is fixed to the another of the four sides of the first board. The second board further includes another two holes defined in another of the four sides of the second board corresponding to the another of the four sides of the first board. Each of the first and second fastening straps further includes another end adapted to extend through one of the another two holes of the second board. The second engagement side of the first fastening strap is adapted to releasably engage with the first engagement side of the second fastening strap for detachably binding the second board to the first board.

In an alternative example, the paper binding device further includes first and second fastening straps. Each of the first fastening strap and the second fastening strap includes a first engagement side and a second engagement side. The second engagement side of the first fastening strap is configured to repeatedly and releasably engage with the first engagement side of the second fastening strap. The first engagement side at an end of the first fastening strap is fixed to another of the four sides of the first board. The second engagement side at an end of the second fastening strap is fixed to the another of the four sides of the first board. The second board further includes another two holes defined in another of the four sides of the second board corresponding to the another of the four sides of the first board. Each of the first and second fastening straps further includes another end adapted to extend through one of the another two holes of the second board. The second engagement side of the first fastening strap is adapted to releasably engage with the first engagement side of the second fastening strap for detachably binding the second board to the first board.

In a second aspect, a paper binding device includes a bottom plate and first and second fastening straps. The bottom plate includes a first end and a second end. Each of the first fastening strap and the second fastening strap includes a first engagement side and a second engagement side. The second engagement side of the first fastening strap is configured to repeatedly and releasably engage with the first engagement side of the second fastening strap. The first engagement side at an end of the first fastening strap is fixed to the first end of the bottom plate. The second engagement side at an end of the second fastening strap is fixed to the second end of the bottom plate.

Each of the first and second fastening straps can be a hook and loop strap. The first engagement side of each of the first and second fastening straps has a plurality of hooks, and the second engagement side of each of the first and second fastening straps has a plurality of loops.

Each of the first and second fastening straps can be made of polyethylene terephthalate (PET) electrostatic film material or a re-adherable strap.

Each of the first and second fastening straps can be fixed to the bottom plate by gluing, heat welding, or supersonic welding.

The paper binding device can further include an adhesive layer provided on a side of the bottom plate opposite to the first and second fastening straps.

In an example, the paper binding device further includes a first board and a second board. The bottom plate mounted to one of four sides of the first board. Two holes defined in one of four sides of the second board corresponding to the one of the four sides of the first board. Each of the first and second fastening straps further includes another end adapted to extend through one of the two holes of the second board before the second engagement side of the first fastening strap engages with the first engagement side of the second fastening strap for detachably binding the second board to the first board.

In another example, the paper binding device further includes a third fastening strap mounted to another of the four sides of the first board. The third fastening strap includes a first engagement side and a second engagement side configured to repeatedly and releasably engage with the first engagement side of the third fastening strap. A portion of the first or second engagement side of the third fastening strap is fixed to the another of the four sides of the first board. The second board further includes another two holes defined in another of the four sides of the second board corresponding to the another of the four sides of the first board. The third fastening strap includes two ends adapted to extend through the another two holes of the second board before the first engagement side of the third fastening strap engages with the second engagement side of the third fastening strap for detachably binding the second board to the first board.

In a further example, the bottom board forms a first board having four sides. The first engagement side at the end of the first fastening strap and the second engagement side at the end of the second fastening strap are fixed to one of the four sides of the first board. The paper binding device further includes a second board. Two holes defined in one of four sides of the second board corresponding to the one of the four sides of the first board. Each of the first and second fastening straps includes another end adapted to extend through the two holes of the second board before the second engagement side of the first fastening strap engages with the first engagement side of the second fastening strap for detachably binding the second board to the first board.

Each of the first board and the second board can be made of a plastic board, a rigid paper board, or a plastic board that is transparent, opaque, or translucent. The first board and the second board can be made of identical material or different materials.

The present invention will become clearer in light of the following detailed description of illustrative embodiments of this invention described in connection with the drawings.

### DESCRIPTION OF THE DRAWINGS

FIG. 1A is an exploded, perspective view of a conventional paper fastener for binding paper.

FIG. 1B is a perspective view of the conventional paper fastener and the paper shown in FIG. 1A.

FIG. 2 is a top, perspective view of a paper binding device of a first embodiment according to the present invention for binding paper.

FIG. 3 is a top, perspective view of a paper binding device of a second embodiment according to the present invention.

FIG. 4 is an exploded, perspective view of a paper binding device file of a third embodiment according to the present invention.

FIG. 5 is an exploded, perspective view of a paper binding device of a fourth embodiment according to the present invention.

FIG. 6 is an exploded, perspective view of a paper binding device of a fifth embodiment according to the present invention.

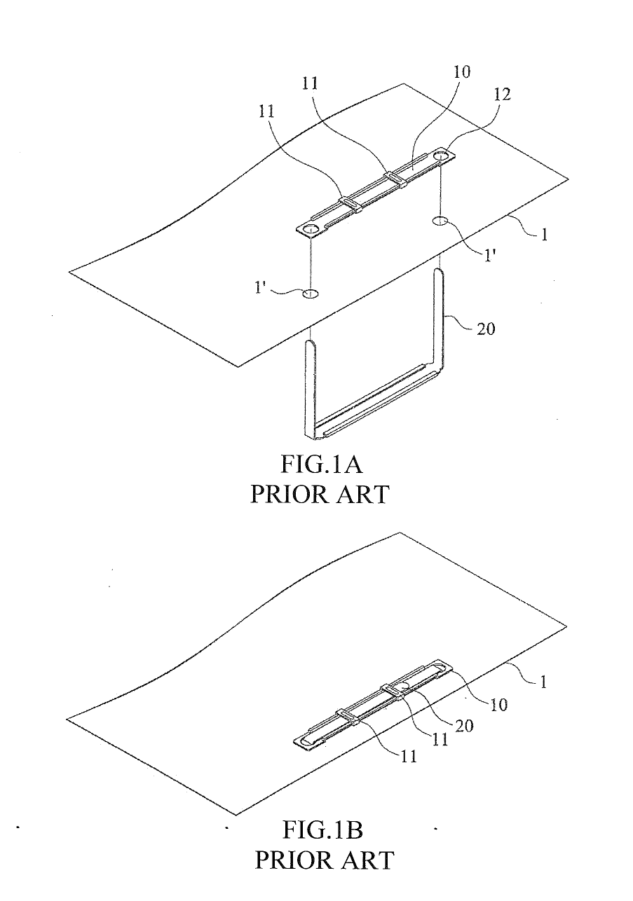

### DETAILED DESCRIPTION OF THE INVENTION

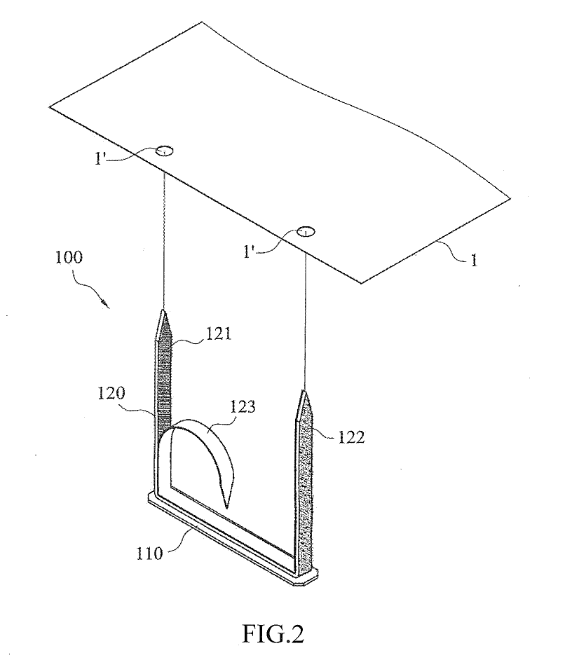

A paper binding device 100 of a first embodiment according to the present invention for binding paper will now be described with reference to FIG. 2.

As can be seen from FIG. 2, the paper binding device is in the form of a paper fastener 100 including a bottom plate 110 and a fastening strap 120. The bottom plate 110 can be rigid and made of polyvinyl chloride. In the embodiment shown in FIG. 2, the fastening strap 120 is an elongated strap having hook and loop fasteners. Specifically, the fastening strap 120 includes a first engagement side 121 having a plurality of hooks and a second engagement side 122 having a plurality of loops. In other embodiments, the fastening strap 120 can be an elongated strap permitting repeated engagement and disengagement, such as a strap made of polyethylene terephthalate (PET) electrostatic film material or a re-adherable strap made by 3M Company.

As can be seen from FIG. 2, the fastening strap 120 is fixed to the bottom plate 110 by bonding a portion of the second engagement side 122 having the loops to the bottom plate 110. In another example, the fastening strap 120 can be fixed to the bottom plate 110 by bonding a portion of the first engagement side 121 having the hooks to the bottom plate 110. In addition to gluing, the bonding between the fastening strap 120 and the bottom plate 110 can be achieved by heat welding or supersonic welding. Furthermore, to prevent the paper fastener 100 according to the present invention from improperly engaging with other paper fasteners 100 during transportation and storage, a peel paper 123 can be mounted to a side of the fastening strap 120 opposite to the bottom plate 110. In this embodiment, the peel paper 123 is mounted on the first engagement side 121 having the hooks.

In use, two ends of the fastening strap 120 extend through the holes 1′ of the paper 1. Then, the first engagement side 121 at an end of the fastening strap 120 is engaged with the second engagement side 122 at the other end of the fastening strap 120, accomplishing binding of the paper 1.

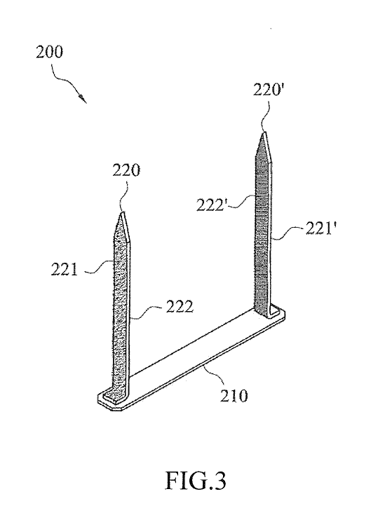

FIG. 3 shows a paper binding device 200 of a second embodiment according to the present invention. In this embodiment, the paper binding device is in the form of a paper fastener 200 including a bottom plate 210, a first fastening strap 220, and a second fastening strap 220′. The bottom plate 210 can be a rigid plate. In this embodiment, each of the first fastening strap 220 and the second fastening strap 220′ is a strap having hook and loop fasteners. Specifically, each of the first fastening strap 220 and the second fastening strap 220′ includes a first engagement side 221, 221′ having a plurality of hooks and a second engagement side 222, 222′ having a plurality of loops. In other embodiments, each of the first fastening strap 220 and the second fastening strap 220′ can be an elongated strap permitting repeated engagement and disengagement, such as a strap made of polyethylene terephthalate (PET) electrostatic film material or a re-adherable strap made by 3M Company.

As can be seen from FIG. 3, the first fastening strap 220 is fixed to the bottom plate 210 by bonding an end of the second engagement side 222 to an end of the bottom plate 210. The second fastening strap 220′ can be fixed to the bottom plate 210 by bonding an end of the second engagement side 222′ to the other end of the bottom plate 210.

In use, the free ends of the first fastening strap 220 and the second fastening strap 220′ extend through the holes of the paper to be bound. Then, the first engagement side 221 of the first fastening strap 220 is engaged with the second engagement side 222′ of the second fastening strap 220′, accomplishing binding of the paper.

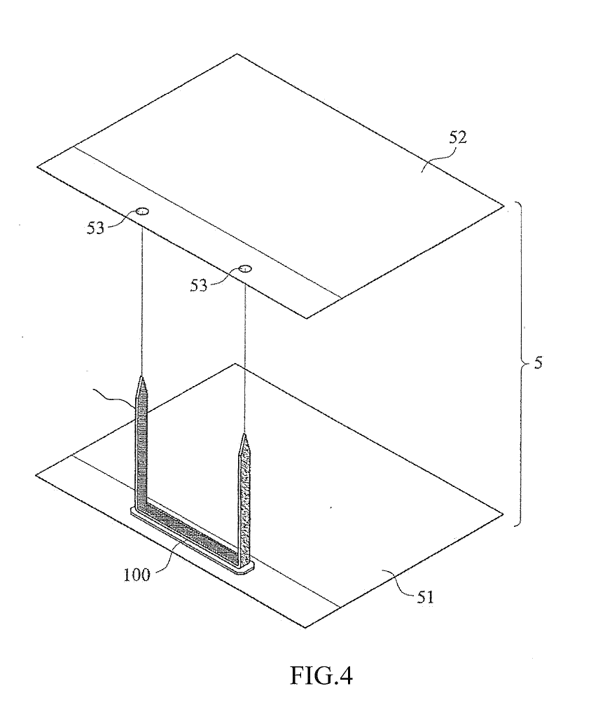

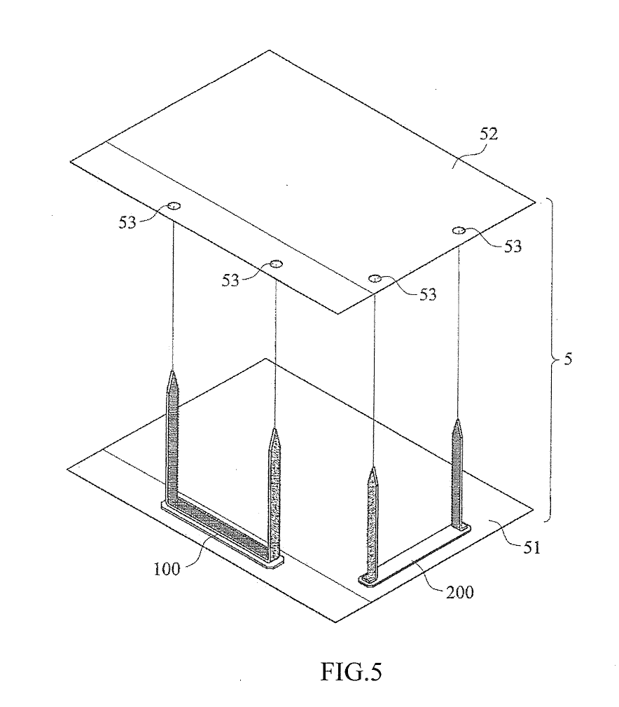

FIG. 4 shows a paper binding device of a third embodiment according to the present invention. As can be seen from FIG. 4, the paper binding device is in the form of a file 5 including a first board 51 having four sides, and a paper fastener 100 of the first embodiment is mounted to one of the four sides (e.g., the left side) of the first board 51. The file 5 further includes a second board 52 also having four sides. A corresponding side (e.g., the left side) of the second board 52 has two holes 53 for receiving two ends of the fastening strap 120, such that the second board 52 can be detachably coupled to the first board 51 to form the file 5 including a bottom board and a top board. Although the paper fastener 100 is mounted to the left side of the first board 51 in this embodiment, an additional paper fastener 100 or 200 can be mounted to another side of the first board 51. As an example, a paper fastener 200 can be mounted to the top side of the first board 51, and two holes 53 are correspondingly formed in the top side of the second board 52, as shown in FIG. 5 illustrating the paper binding device of a fourth embodiment also in the form of a file 5.

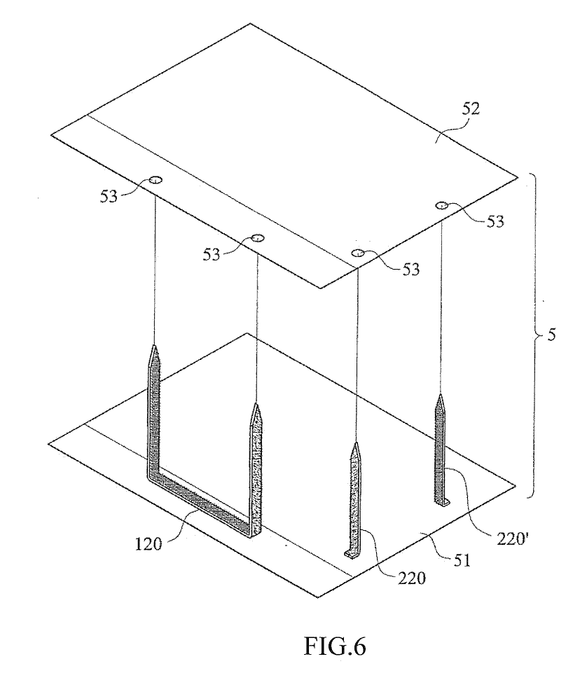

FIG. 6 shows a paper binding device of a fifth embodiment according to the present invention also in the form of a file 5, wherein a fastening strap 120 is mounted on the right side of the first board 51, and first and second fastening straps 220 and 220′ are mounted on the top side of the first board 51. The first board 51 of this embodiment can be deemed as a modification (an enlarged version) of the bottom board 110 of the paper fastener 100.

It can be appreciated that the paper binding device of FIG. 5 does not have to include the bottom plate 210 of the paper fastener 200, and the first and second fastening straps 220 and 220′ are directly fixed to the first board 51. Likewise, the paper binding device of FIG. 5 does not have to include the bottom board 110 of the paper fastener 100, and the fastening strap 120 is directly fixed to the first board 51.

Each of the first board 51 and the second board 52 can be made of a plastic board, a rigid paper board, or a plastic board that is transparent, opaque, or translucent. Furthermore, the first board 51 and the second board 52 can be made of identical material or different materials. The paper fastener 100 can be fixed to the first board 51 by bonding or any other suitable provision, such as gluing, heat welding, or supersonic welding.

Although specific embodiments have been illustrated and described, numerous modifications and variations are still possible without departing from the scope of the invention. For example, an adhesive layer (not shown) can be provided on a side of the bottom plate 110 of the paper fastener 100 opposite to the fastening strap 120, such that the paper fastener 100 according to the present invention can be fixed to an object, such as a bulletin board or a white board, to provide the object with a paper binding function. Thus, other possible modifications and variations fall within the true scope of the invention defined by the accompanying claims and their equivalents.

1. A paper binding device comprising:
a bottom plate; and
a fastening strap, with the fastening strap being elongated and including a first engagement side and a second engagement side configured to repeatedly and releasably engage with the first engagement side, and with a portion of the first engagement side or a portion of the second engagement side fixed to the bottom plate.

2. The paper binding device as claimed in claim 1, with the fastening strap being a hook and loop strap, with the first engagement side having a plurality of hooks, and with the second engagement side having a plurality of loops.

3. The paper binding device as claimed in claim 1, wherein the fastening strap is made of polyethylene terephthalate (PET) electrostatic film material or a re-adherable strap.

4. The paper binding device as claimed in claim 1, wherein the fastening strap is fixed to the bottom plate by gluing, heat welding, or supersonic welding.

5. The paper binding device as claimed in claim 1, further comprising a peel paper mounted to one of the first and second engagement sides of the fastening strap opposite to the bottom plate.

6. The paper binding device as claimed in claim 1, further comprising an adhesive layer provided on a side of the bottom plate opposite to the fastening strap.

7. The paper binding device as claimed in claim 1, further comprising:
a first board including four sides, with the bottom plate mounted to one of the four sides of the first board; and
a second board including four sides, with two holes defined in one of the four sides of the second board corresponding to the one of the four sides of the first board, with the fastening strap including two ends adapted to extend through the two holes of the second board before the first engagement side engages with the second engagement side for detachably binding the second board to the first board.

8. The paper binding device as claimed in claim 7, further comprising:
another bottom board fixed to another of the four sides of the first board and including first and second ends; and
first and second fastening straps, with each of the first fastening strap and the second fastening strap including a first engagement side and a second engagement side, with the second engagement side of the first fastening strap configured to repeatedly and releasably engage with the first engagement side of the second fastening strap, with the first engagement side at an end of the first fastening strap fixed to the first end of the another bottom plate, and with the second engagement side at an end of the second fastening strap fixed to the second end of the another bottom plate,
with the second board further including another two holes defined in another of the four sides of the second board corresponding to the another of the four sides of the first board, with each of the first and second fastening straps further including another end adapted to extend through one of the another two holes of the second board, and with the second engagement side of the first fastening strap adapted to releasably engage with the first engagement side of the second fastening strap for detachably binding the second board to the first board.

9. The paper binding device as claimed in claim 1, with the bottom board forming a first board, with the first board including four sides, with the portion of the first engagement side or the portion of the second engagement side fixed to one of the four sides of the first board, with the paper binding device further comprising:
a second board including four sides, with two holes defined in one of the four sides of the second board corresponding to the one of the four sides of the first board, with the fastening strap including two ends adapted to extend through the two holes of the second board before the first engagement side of the fastening strap engages with the second engagement side of the fastening strap for detachably binding the second board to the first board.

10. The paper binding device as claimed in claim 9, further comprising:
first and second fastening straps, with each of the first fastening strap and the second fastening strap including a first engagement side and a second engagement side, with the second engagement side of the first fastening strap configured to repeatedly and releasably engage with the first engagement side of the second fastening strap, with the first engagement side at an end of the first fastening strap fixed to another of the four sides of the first board, and with the second engagement side at an end of the second fastening strap fixed to the another of the four sides of the first board,
with the second board further including another two holes defined in another of the four sides of the second board corresponding to the another of the four sides of the first board, with each of the first and second fastening straps further including another end adapted to extend through one of the another two holes of the second board, and with the second engagement side of the first fastening strap adapted to releasably engage with the first engagement side of the second fastening strap for detachably binding the second board to the first board.

11. The paper binding device as claimed in claim 7, further comprising:
first and second fastening straps, with each of the first fastening strap and the second fastening strap including a first engagement side and a second engagement side, with the second engagement side of the first fastening strap configured to repeatedly and releasably engage with the first engagement side of the second fastening strap, with the first engagement side at an end of the first fastening strap fixed to another of the four sides of the first board, and with the second engagement side at an end of the second fastening strap fixed to the another of the four sides of the first board,
with the second board further including another two holes defined in another of the four sides of the second board corresponding to the another of the four sides of the first board, with each of the first and second fastening straps further including another end adapted to extend through one of the another two holes of the second board, and with the second engagement side of the first fastening strap adapted to releasably engage with the first engagement side of the second fastening strap for detachably binding the second board to the first board.

12. A paper binding device comprising:
a bottom plate including a first end and a second end; and
first and second fastening straps, with each of the first fastening strap and the second fastening strap including a first engagement side and a second engagement side, with the second engagement side of the first fastening strap configured to repeatedly and releasably engage with the first engagement side of the second fastening strap, with the first engagement side at an end of the first fastening strap fixed to the first end of the bottom plate, and with the second engagement side at an end of the second fastening strap fixed to the second end of the bottom plate.

13. The paper binding device as claimed in claim 12, with each of the first and second fastening straps being a hook and loop strap, with the first engagement side of each of the first and second fastening straps having a plurality of hooks, and with the second engagement side of each of the first and second fastening straps having a plurality of loops.

14. The paper binding device as claimed in claim 12, wherein each of the first and second fastening straps is made of polyethylene terephthalate (PET) electrostatic film material or a re-adherable strap.

15. The paper binding device as claimed in claim 12, wherein each of the first and second fastening straps is fixed to the bottom plate by gluing, heat welding, or supersonic welding.

16. The paper binding device as claimed in claim 12, further comprising an adhesive layer provided on a side of the bottom plate opposite to the first and second fastening straps.

17. The paper binding device as claimed in claim 12, further comprising:
a first board including four sides, with the bottom plate mounted to one of the four sides of the first board; and
a second board including four sides, with two holes defined in one of the four sides of the second board corresponding to the one of the four sides of the first board, with each of the first and second fastening straps further including another end adapted to extend through one of the two holes of the second board before the second engagement side of the first fastening strap engages with the first engagement side of the second fastening strap for detachably binding the second board to the first board.

18. The paper binding device as claimed in claim 17, further comprising:
a third fastening strap mounted to another of the four sides of the first board, with the third fastening strap including a first engagement side and a second engagement side configured to repeatedly and releasably engage with the first engagement side of the third fastening strap, and with a portion of the first or second engagement side of the third fastening strap fixed to the another of the four sides of the first board,
with the second board further including another two holes defined in another of the four sides of the second board corresponding to the another of the four sides of the first board, with the third fastening strap including two ends adapted to extend through the another two holes of the second board before the first engagement side of the third fastening strap engages with the second engagement side of the third fastening strap for detachably binding the second board to the first board.

19. The paper binding device as claimed in claim 12, with the bottom board forming a first board, with the first board including four sides, with the first engagement side at the end of the first fastening strap and the second engagement side at the end of the second fastening strap fixed to one of the four sides of the first board, with the paper binding device further comprising:
a second board including four sides, with two holes defined in one of the four sides of the second board corresponding to the one of the four sides of the first board, with each of the first and second fastening straps including another end adapted to extend through the two holes of the second board before the second engagement side of the first fastening strap engages with the first engagement side of the second fastening strap for detachably binding the second board to the first board.

20. The paper binding device as claimed in 17, wherein each of the first board and the second board is made of a plastic board, a rigid paper board, or a plastic board that is transparent, opaque, or translucent, and wherein the first board and the second board are made of identical material or different materials.
